(19) United States
(12) Patent Application Publication
(10) Pub. No.: US 2008/0215639 A1
(43) Pub. Date: Sep. 4, 2008

(54) Data Synchronization

(75) Inventors: Brian Rifkin, New York, NY (US); Rob Wertheim, Leiderdorp (NL)

Correspondence Address: FISH & RICHARDSON P.C., P.O. BOX 1022, MINNEAPOLIS, MN, 55440-1022, US

(73) Assignee: iMusicDrive, LLC, New York, NY (US)

(21) Appl. No.: 11/966,166

(22) Filed: Dec. 28, 2007

Related U.S. Application Data
(60) Provisional application No. 60/883,462, filed on Jan. 4, 2007.

(51) Int. Cl. G06F 17/30

(52) U.S. Cl. 707/203; 707/E17.007

(57) ABSTRACT

Synchronizing data between two data storage devices includes receiving, from an operating system, a file system message that includes an instruction to modify a first data storage device and executing the instruction on first and second data storage devices. In some implementations, the synchronization can create mirrored data without the need for additional hardware components.

### CROSS-REFERENCE TO RELATED APPLICATION(S)

This application claims priority from U.S. Provisional Application 60/883,462 filed on Jan. 4, 2007, the disclosure of which is incorporated herein by reference.

### BACKGROUND

This disclosure relates to data synchronization between data storage devices. In computing, a redundant array of inexpensive discs (RAID) is a system which uses multiple hard drives to share or replicate data among the drives. In short, the RAID system creates an exact copy (or mirror) of a set of data on each drive. A common feature of RAID systems entails combining the multiple hard drives into a single logical unit so that instead of seeing several different hard drives, the operating system sees only one. The benefit of a RAID system is that it may provide a significant increase in data reliability over a single drive.

Standard RAID systems usually require an expensive hardware component known as a RAID controller which handles the management of data between the drives. However, the cost of this component places the price of a RAID system well out of an average consumer's budget. Furthermore, various internal and external RAID controllers exist which may be drive-dependent, thereby restricting the ability of a user to interchange different hard drives such as magnetic disk drives, optical disk drives or floppy disk drives.

### SUMMARY

The details of one or more embodiments of the invention are set forth in the description below, the accompanying drawings and the claims.

For example, in one aspect, a computer-implemented method of synchronizing data between two data storage devices includes receiving, from an operating system, a file system message that includes an instruction to modify a first data storage device and executing the instruction on first and second data storage devices.

In another aspect, an article includes a machine-readable medium which stores machine-executable instructions that, when applied to a machine, cause the machine to intercept file system messages, supplied by an operating system, before the file system messages are received by a file system event handler. The machine-executable instructions further cause the machine to record, in a log file, intercepted file system messages that include instructions to modify a first data storage device. The machine-executable instructions further cause the machine to read the recorded instructions from the log file and execute the recorded instructions on a second storage device.

In another aspect, a system for synchronizing data between two data storage devices includes a first data storage device, a second data storage device, a graphical user interface, an operating system, a file system event handler, a log file and application software stored by the system, which is configured to: intercept file system messages, provided by the operating system, before the file system messages are received by the file system event handler; record, in the log file, an intercepted file system message that includes an instruction to modify the first data storage device; read the instruction; and execute the instruction on the second data storage device.

Some implementations include one or more of the following features.

For example, receiving the file system message includes intercepting file system messages from the operating system before the file system messages are received by a file system event handler. The intercepted file system messages are recorded in a log file. The instructions then are read from the log file.

In some examples, intercepted file system messages that do not include an instruction to modify a first data storage device are passed to the file system event handler.

In some implementations, the intercepted file system message that includes an instruction to modify a first data storage device is passed to the file system event handler after the intercepted file system message that includes an instruction to modify a first data storage device has been recorded in the log file.

In certain implementations, reading and executing the instruction on the first data storage device occur directly after recording the intercepted file system message in the log file.

In some examples, reading and executing the instruction on the second data storage device do not occur until a fixed time period has elapsed after recording the intercepted file system message in a log file.

In some implementations, reading and executing the instruction on the second data storage device occur in response to a user-initiated command.

In some implementations, the application software is configured to read and execute the instruction in response to a user-initiated command, in which the user-initiated command is received through the graphical user interface.

In certain implementations, synchronizing data between two data storage devices includes verifying that the second data storage device includes a copy of the data stored on the first data storage device.

In some examples, synchronizing data between two data storage devices includes copying data that is not included on the second data storage device, from the first data storage device to the second data storage device and deleting data that is not included on the first data storage device from the second storage device.

In some implementations, synchronizing data between two data storage devices includes verifying the data stored on the first data storage device and on the second data storage device are not corrupted.

In certain implementations, the instruction to modify a first data storage device includes one or more of the following instructions: renaming a file, renaming a folder, deleting a file, deleting a folder, creating a file, creating a folder and modifying a file.

In some implementations, the article further includes instructions that, when applied to the machine, cause the machine to pass the intercepted file system messages to the file system event handler.

In some examples, the article further includes instructions that, when applied to the machine, cause the machine to pass the intercepted file system message that includes an instruction to modify a first data storage device to the file system event handler after the intercepted file system message that includes an instruction to modify a first data storage device has been recorded in the log file.

In some implementations, the article further includes instructions that, when applied to the machine, cause the machine to hide the appearance of the second data storage device on the machine from the user.

In certain implementations, the first data storage device comprises magnetic, optical or semiconductor read-write memory. In some implementations, the second data storage device comprises magnetic, optical or semiconductor read-write memory. In some examples, the first data storage device and the second data storage device comprise the same type of memory. In some examples, the log file is a text file.

Other features and various advantages of the invention will be readily apparent from the description, drawings, and from the claims.

### BRIEF DESCRIPTION OF DRAWINGS

FIG. 1 shows a block diagram of a computer system connected to data storage devices.

FIG. 2A is a flow chart of system messages from an operating system.

FIG. 2B shows an example of system parameters included in a system message.

FIG. 3 shows a block diagram of a data synchronization operation.

FIGS. 4-9 are example screen shots of displays provided during the process of transferring files from the hard disk drive to the first data storage device.

FIGS. 10-14 are example screen shots of displays provided during the process of reclaiming disk space on the user's hard disk drive.

### DETAILED DESCRIPTION

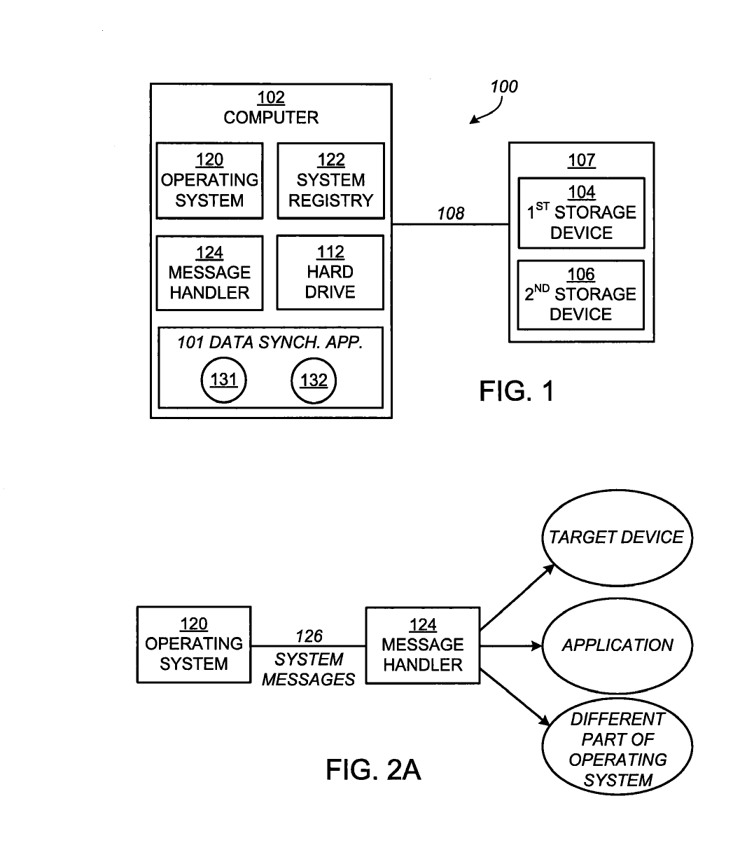

As shown in FIG. 1, a computer system 100 includes a computer 102 coupled through signal lines 108 to a first external data storage device 104 and a second external data storage device 106. The first and second data storage devices can be enclosed within a single chassis or enclosure 107 that includes connection ports for the signal lines 108. The computer 102 can include both internal and external components such as a hard disk drive 112, memory, a display monitor, a keyboard and a mouse.

In particular implementations, the data storage devices include any conventional data storage media such as hard disk drives, magnetic disk drives, optical disk drives or floppy disk drives. Other data storage devices can be used as well. Examples of signal lines 108 that connect the data storage device to the computer 102 include serial bus interface standards such as universal serial bus (USB), IEEE 1394 standard (FireWire), RS-232, peripheral component interconnect (PCI), serial advanced technology attachment (ATA) and serially attached small computer system interface (SCSI).

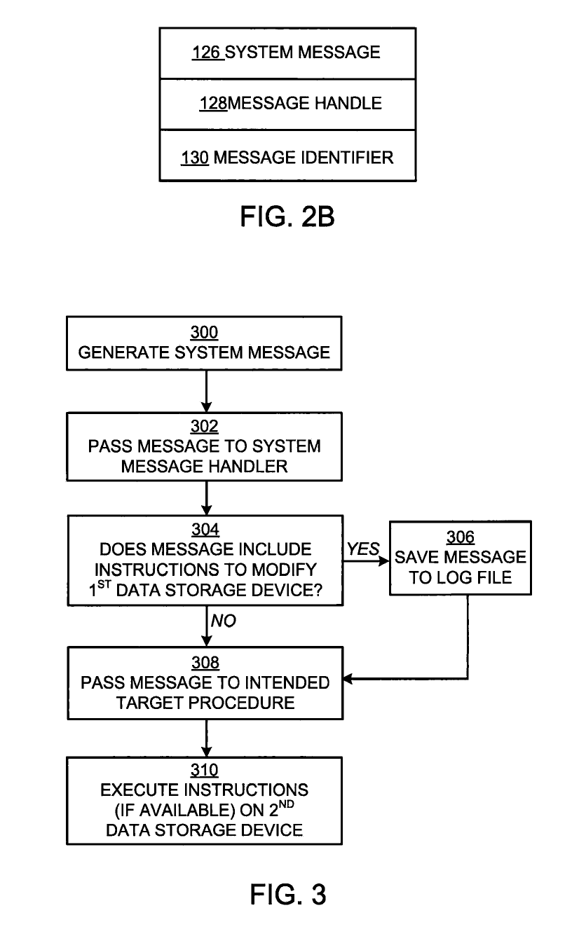

In addition, the computer 102 also stores an operating system 120, a system registry 122 and a system message handler 124. Examples of typical operating systems include Windows® based operating systems such as Windows 95, Windows NT, Windows 2000 or Windows XP. The system registry 122 includes a database that stores data about applications, drivers, user preferences, and other configuration settings of the computer 102. The system message handler 124 serves to pass system messages 126 from the operating system 120 to target devices, applications or procedures (see FIG. 2A) of the computer system 100. Typically, system messages 126 are generated in response to system events. System events can occur due to user-initiated actions including, for example, moving the mouse or typing on the keyboard. Alternatively, system events can occur due to application initiated actions such as file deletion or modification.

In some implementations, system messages 126 are sent with a set of parameters that describe the message (see FIG. 2B). The parameters may include, for example, a message handle 128 and a message identifier 130. The message handle 128 specifies the destination of the system message 126 and can be used to determine which device or application receives the message 126. The message identifier 130 identifies the purpose of the message. For example, when a device receives the system message 126, it can use the message identifier 130 to determine how to process the message.

A data synchronization application 101 installed on the computer 102 serves to provide synchronization or “mirroring” of data stored on the first and second data storage devices 104, 106 through the use of software modules 131 and 132. In particular, the data synchronization application 101 intercepts system messages that include instructions to modify the first data storage device 104. Before passing the intercepted system messages to their intended destination in the operating system, the application 101 copies the system messages to a log file. In response to either a user-initiated or scheduled request, the data synchronization application 101 then applies the copied instructions to the second data storage device 106, ensuring that any file modification performed on the first data storage device 104 is also performed on the second data storage device 106. Subsequently, files and folders transferred to the first data storage device 104 also are backed-up by the second data storage device 106, and files and folders removed from the first data storage device 104 are deleted from the second data storage device 106. Similarly, files and folders modified on the first data storage device also are modified on the second data storage device.

The data synchronization application 101 performs additional functions including: removing data from its original location after transferring to the data storage device 106; periodic backup of data stored on the data storage device 104; periodic reminders to the user of scheduled synchronization events; verifying file and data integrity of the data storage devices 104, 106; and automatic updating of application features to ensure the application software code stays current.

### Application Installation

Upon installation of the data synchronization application 101 to the computer, the first software module 131 is installed to “hide” the second data storage device 106 from a user. A “hidden” device does not appear available in file directories and cannot be accessed directly by the user. In order to hide the storage device 106, the module 131 copies a “hide” file stored on the second data storage device 106 to the system registry 122 during a boot operation of the operating system 120. Additionally, the module 131 also copies a “visible” file stored on the first data storage device 104 to the system registry 122. A “visible” device appears in file directories and can be accessed directly by the user. As a result, the two separate data storage devices 104, 106 may appear to the user as a single data storage device.

In a particular embodiment, visible drives may be represented by a letter. For example, a drive may be labeled “A,” “C” or “D.” In addition, the file directory may correspond to a Windows® file management application that includes, for example, Windows® Explorer or My Computer.

Installation of the data synchronization application 101 also loads the second software module, called a hook 132, within the system message handler 124. The hook module 132 includes a subroutine that monitors and processes all messages 126 passed between the operating system 120 and target procedures. The hook module 132 can filter the messages 126 from the message handler 124 and save the filtered messages to a log file. The messages are filtered depending on their respective message handle 128 and message identifier 130. After saving the filtered messages to a log file, the hook 132 passes along the filtered messages to their designated target procedures in the operating system. Messages not filtered by the hook are passed to their designated target procedures without interruption. When the data synchronization application 101 is uninstalled, both the software module 131 and hook module 132 can be removed from the computer such that the computer 102 functions in the same manner as before installation of the application 101.

### Application Operation

FIG. 3 is a flow chart of the data synchronization operation. The process begins at block 300 when the operating system generates a system message 126 in response to a system event. The operating system then passes the system message 126 to the system message handler 124 in block 302. The hook module 132 evaluates the system message 126 in block 304 to determine if it includes instructions to modify a first data storage device 104. If the system message 126 includes instructions to modify a first data storage device 104, then the hook module 132 saves the instructions to a log file stored on the hard disk 112 of the computer 102 (see block 306). The log file can include, for example, a text file.

In some implementations, the hook 132 filters any system messages 126 that include instructions to modify the first data storage device 104. Examples of instructions that may be filtered by the hook 132 include: renaming a file or folder stored on the first data storage device 104; deleting a file or folder stored on the first data storage device 104; creating a file or folder on the first data storage device 104; and modifying a file stored on the first data storage device 104. These system messages are generated, for example, when a user transfers files from the hard disk.

After the system message 126 has been logged by the hook module 132, the system message handler 124 passes the same message 126 to the intended operating system target procedure in block 308. The target procedure then performs the instructions included in the system message 126 such as, for example, modifying the first data storage device 104. In contrast, if the system message 126 in block 304 does not include instructions to modify a first data storage device 104, the hook module 132 does not save instructions to a log file, and the system message handler 124 passes the message 126 directly to the intended operating system target procedure in block 308. In response to a user-initiated request or to a previously scheduled request, the data synchronization application 101 reads the instructions saved in the log file and executes the instructions on the second data storage device 106 in block 310. In some implementations, the user schedules synchronization requests to occur at specific times and dates, for example, every twenty-four hours, every week or every month. As a result, a mirror copy of data from the first data storage device 104 exists on the second data storage device 106. As the hook module 132 saves the instructions to modify a first data storage device 104 in real-time, the data modified on the second storage device 106 can be considered up to date. The foregoing synchronization process can, therefore, be viewed as analogous to sub real-time data mirroring.

In addition to executing the saved instructions on the second data storage device 106, the synchronization application 101 also can perform a file verification process. The file verification process includes comparing the first and second data storage devices and verifying that the size, hard disk sectors and consistency of both devices are the same. The synchronization application 101 ensures that both the file verification and synchronization processes occur every time the operating system 102 shuts down. Alternatively, the user can schedule the verification and synchronization processes to occur periodically. For example, the user can specify that the synchronization application 101 initiate a synchronization and verification of data storage devices every twenty-four hours.

The synchronization application 101 also can perform a drive cleaning process. The drive cleaning process includes performing a complete synchronization of both storage devices, verifying the amount of free space available on both storage devices, as well as verifying that the files stored on the storage devices have not been corrupted. Relative to the synchronization and verification process, the drive cleaning process may require significantly more time to complete. A user can schedule the drive cleaning process to occur periodically, for example, every thirty days.

Furthermore, the synchronization application 101 can reclaim disk space on the hard disk drive 112 of the computer 102 after backing up files on the first and second data storage devices. For example, the synchronization application 101 can display a message on the computer monitor inquiring whether or not the user would like to delete files that have been transferred and backed-up by the first and second data storage devices. Should the user accept the request, the user then selects which files or folders to remove. The synchronization application 101 then deletes the selected files or folders from the hard disk drive 112 and thus increases the free disk space available to the user.

Additionally, the synchronization application 101 can display periodic prompts to the user in order to remind the user to perform a synchronization of the data storage devices or to free up space on the hard disk drive 112. The synchronization application 101 can also include a help module to aid with troubleshooting problems.

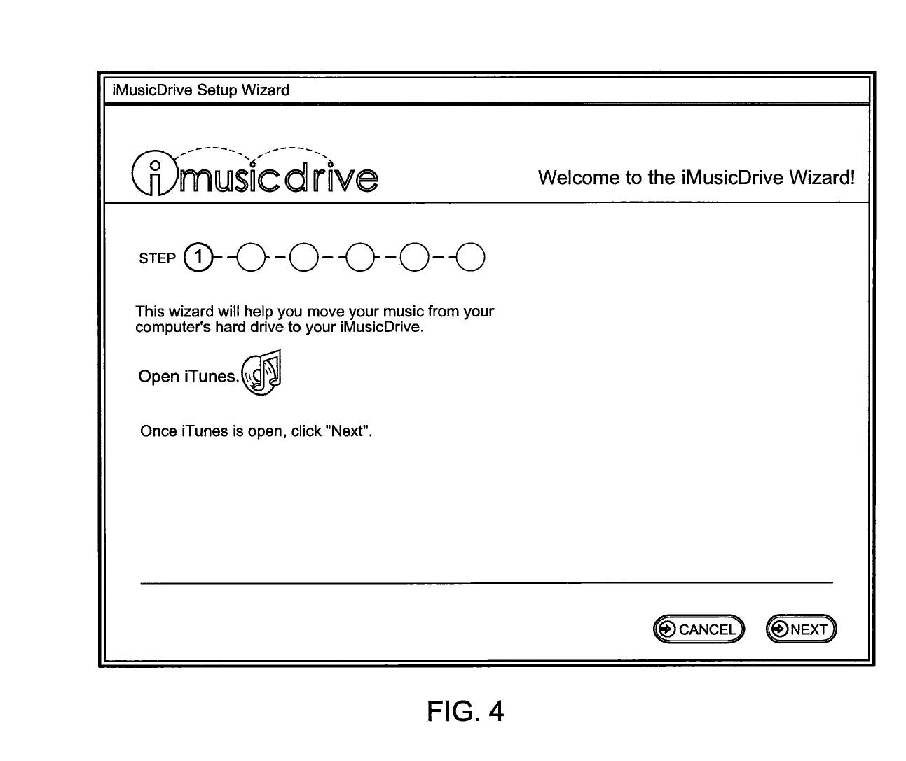

The process of transferring files from the hard disk drive 112 to the first data storage device 104 will now be described in greater detail with reference to the example screens generated by the synchronization application 101 and shown in FIGS. 4-9. These screens guide the user through the application 101 set-up procedure, which includes transferring a folder normally located on the hard disk drive 112 to the first data storage device 104. In addition, the screens prompt the user both to perform an initial backup of the transferred data and to schedule future backups. The user can click Back, Cancel or Next buttons at any point during the set-up process.

In this embodiment, the synchronization application 101 transfers the location of a folder used by a popular music player called iTunes® from the hard disk drive 112 to the first data storage device 104. The hard disk drive 112 is represented in this example by a drive letter “C” and labeled “Local Disk.” The first data storage drive is represented in this example by a drive letter “G” and is labeled “iMusicDrive.” As noted above, a software module 131 loaded during boot-up of the operating system has hidden the second data storage device 106 such that the device 106 does not appear in Windows® Explorer or file tree directories.

FIG. 4 shows a screen displayed after installation and start-up of the synchronization application 101. The user is provided with an informational display that explains the purpose of the setup screens and further prompts the user to open the iTunes® music player.

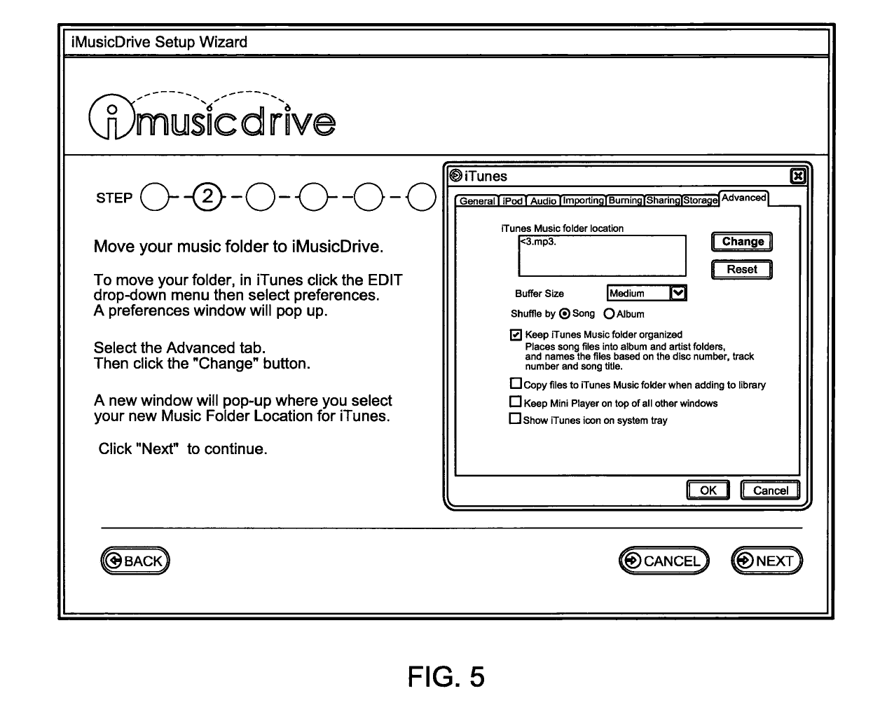

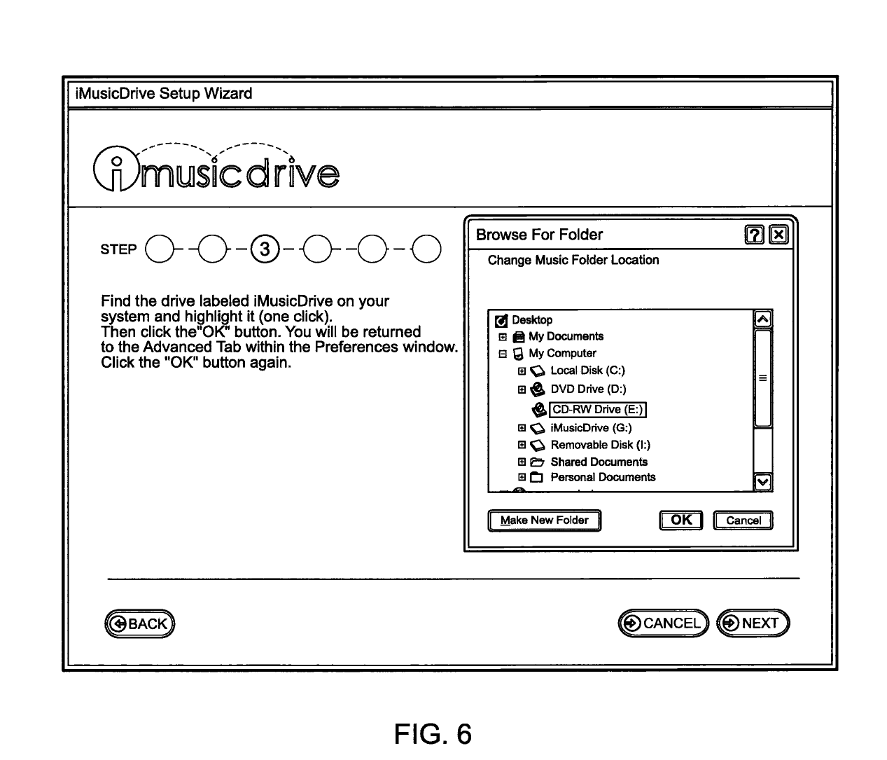

FIGS. 5 and 6 show example screen shots in which the user is prompted to locate and change the destination drive of the iTunes® music folder to the “G” drive or iMusicDrive. The iTunes® music folder is the primary folder to which files downloaded by the iTunes® music player are stored.

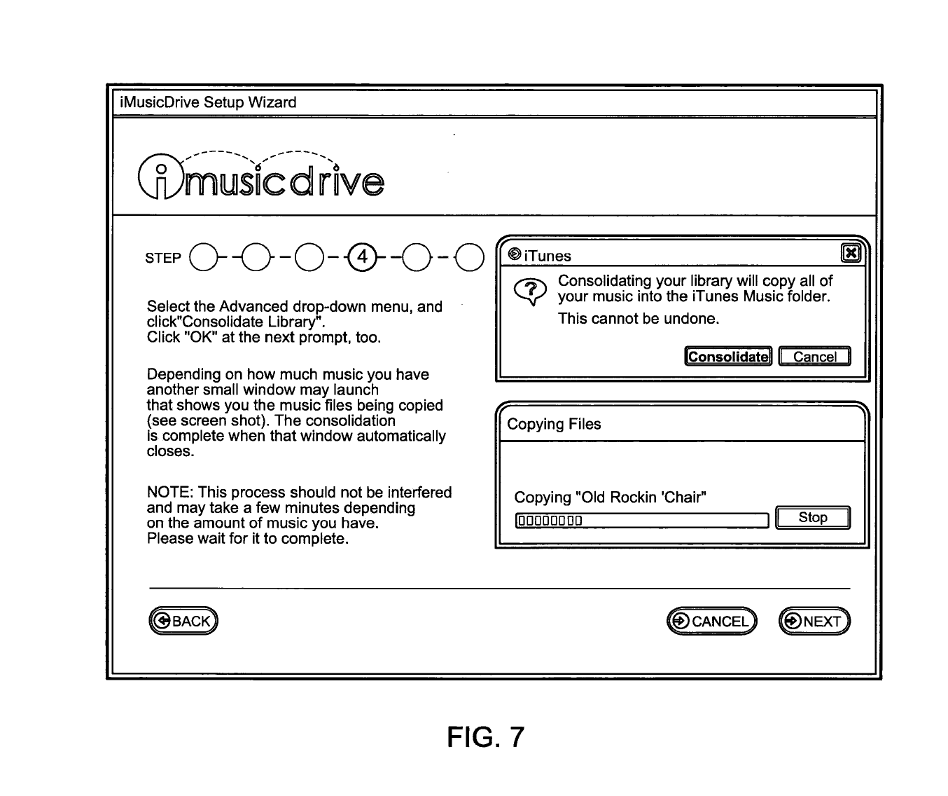

The example screen shown in FIG. 7 instructs the user to select the “Consolidate Library” feature of the music player software. The “Consolidate Library” feature ensures that any music files stored by the system are placed in the iTunes® music folder. Furthermore, since the music folder destination drive was changed (see FIG. 6), selecting the “Consolidate Library” feature also transfers the entire music folder to the first data storage drive, i.e., the iMusicDrive. The original music folder remains, however, on the hard disk drive 112.

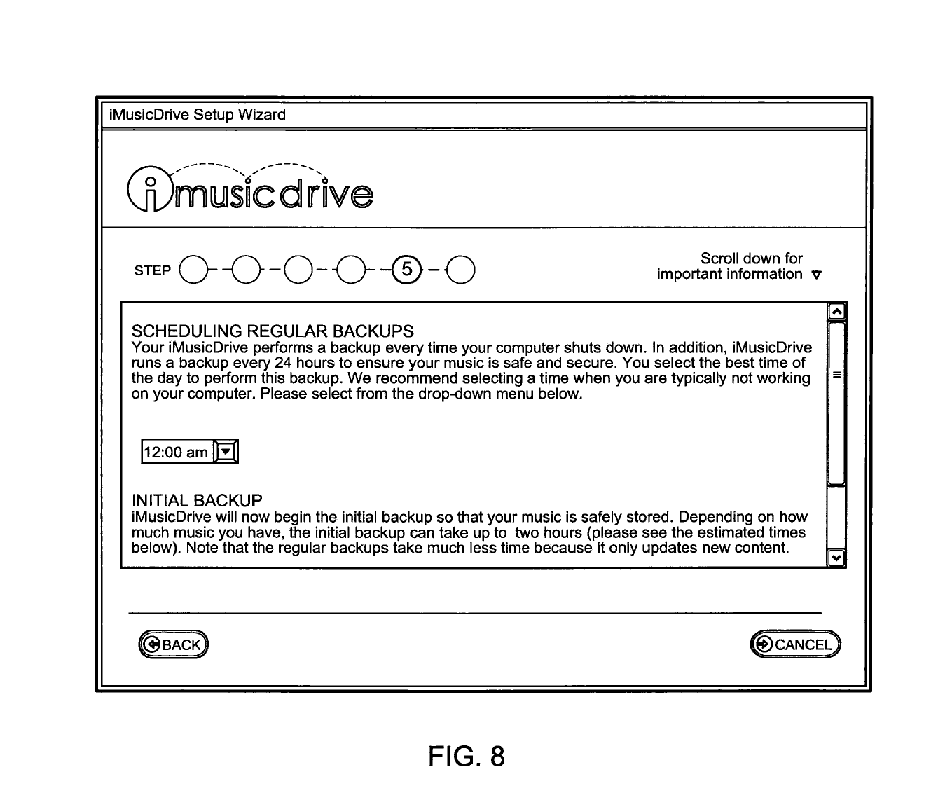

After the music folder is transferred to the iMusicDrive, the example screen shown in FIG. 8 allows the user to schedule a time to perform daily back-ups. The screen also includes a notice to the user regarding back-ups that occur when the operating system shuts down.

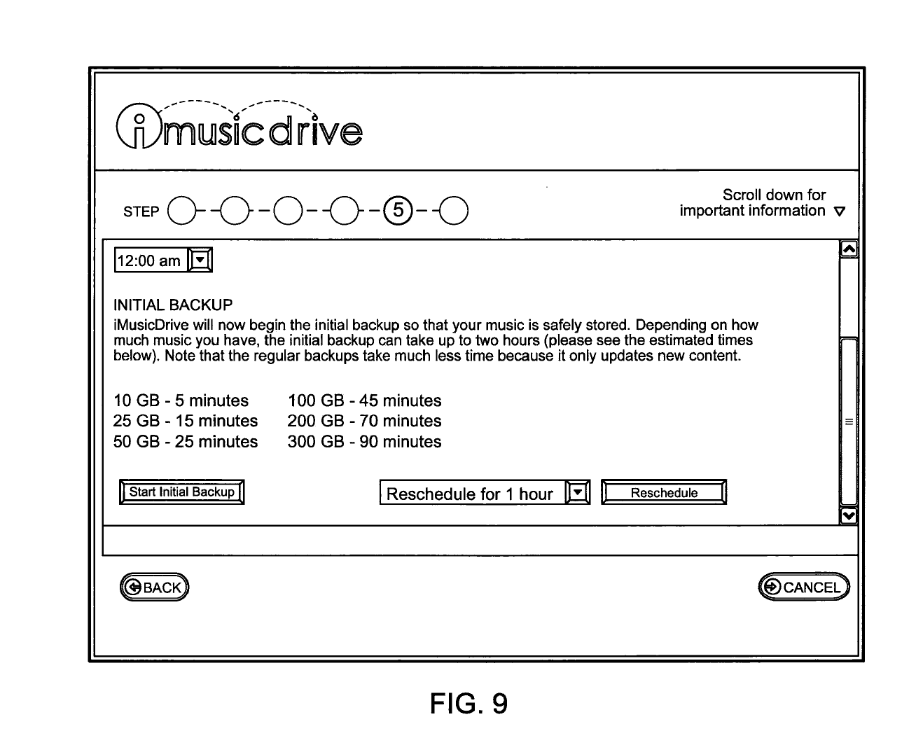

FIG. 9 shows a lower part of the screen displayed in FIG. 8. This portion of the screen prompts the user to begin an initial back-up of the data stored on the iMusicDrive. Once the user selects the “Start Initial Backup” button, the application copies the files stored on the iMusicDrive to the hidden second data storage device 106. Alternatively, the screen of FIG. 9 allows a user to reschedule the initial back-up for a later time.

The user can be prompted to reclaim disk space after a predetermined time has elapsed following the initial copy and backup of the files stored on the iMusicDrive. Should the user choose not to reclaim the disk space at that time, the user can enter a reminder request. After entering the reminder request, a reminder to reclaim disk space will be displayed on the screen at a later time. Scheduling the reminder may be determined by the user or automatically by the application.

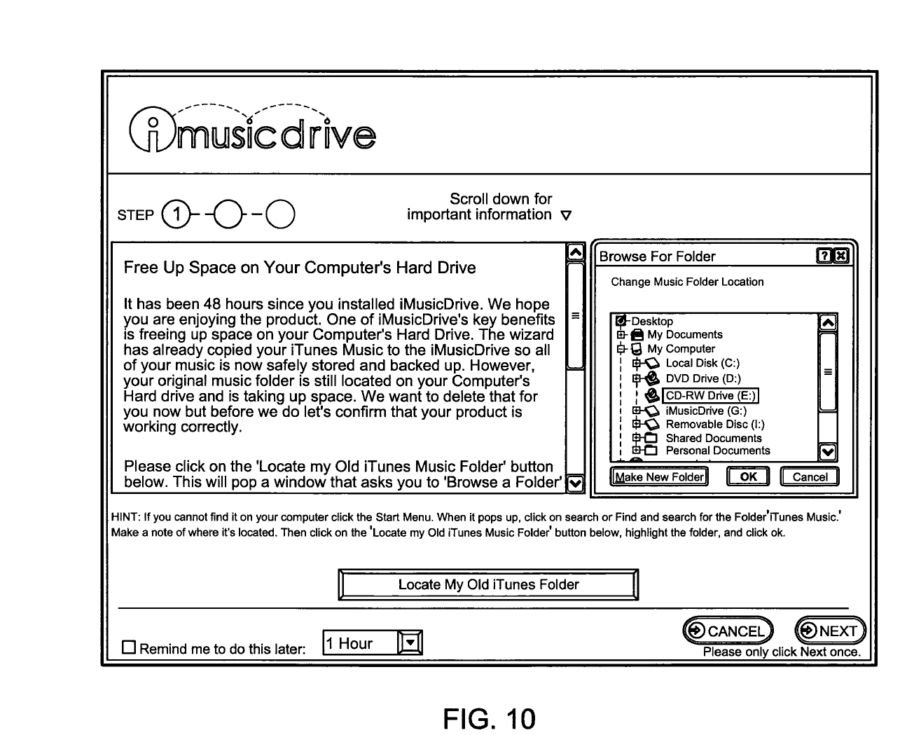

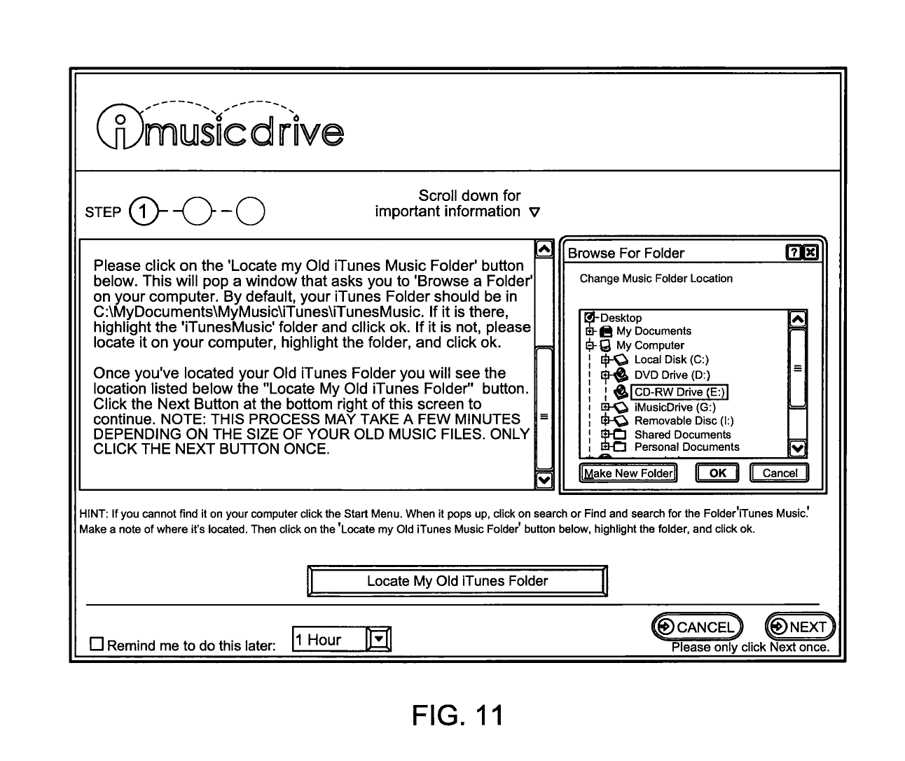

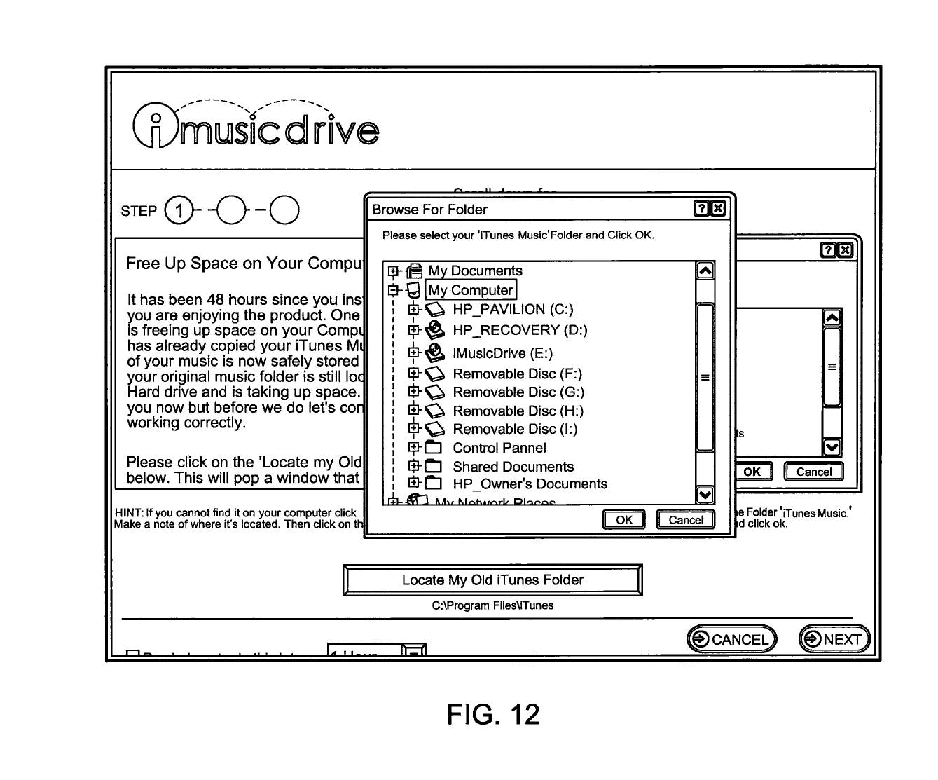

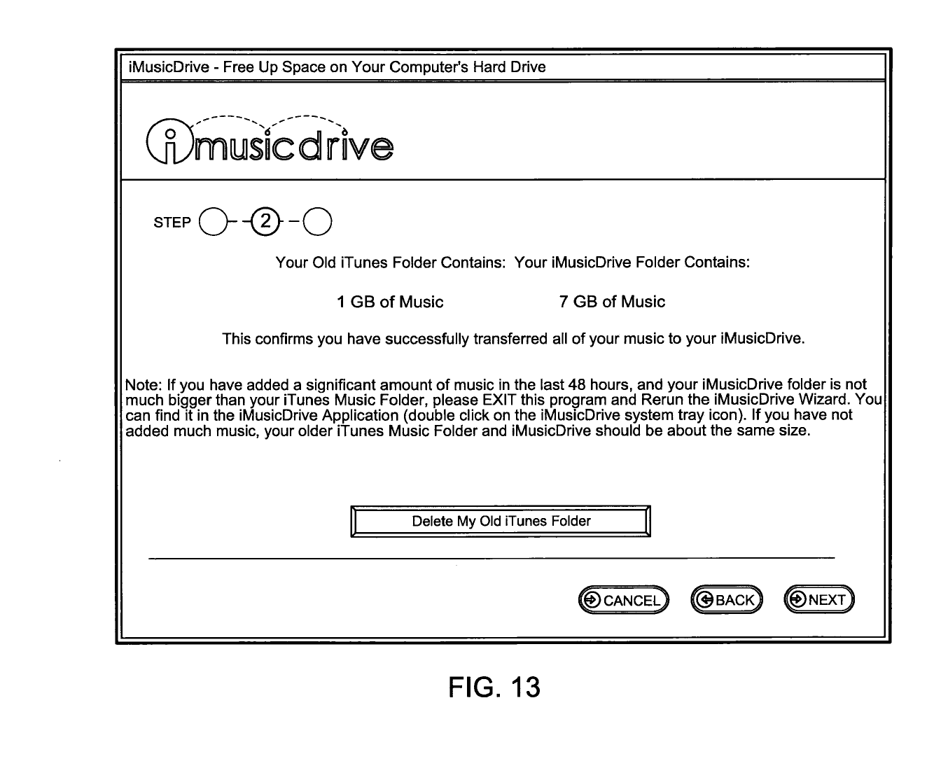

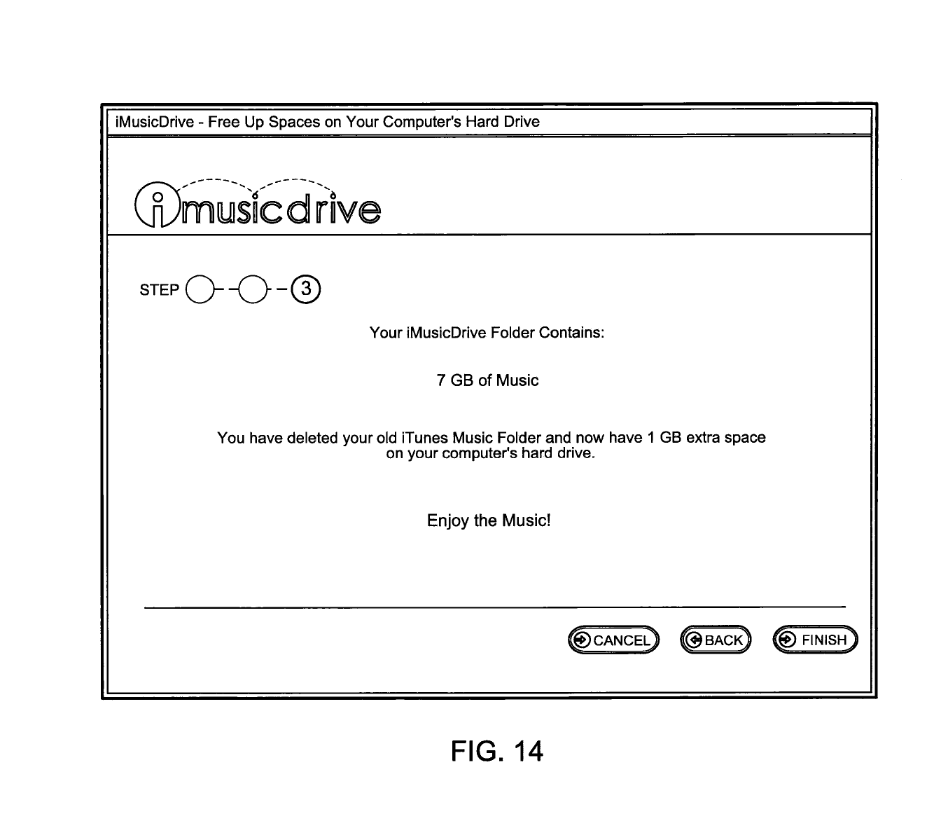

The process of reclaiming disk space on the user's hard disk drive 112 will now be described with reference to the example screens illustrated in FIGS. 10-14. In the screen of FIG. 10, a notification provided to the user indicates the benefits of removing the original music folder from the user's hard disk drive. The screen then directs the user to click on a button labeled “Locate My Old iTunes Folder” (see FIG. 11). After clicking on the button, a file directory is displayed from which the user may select the original location of the music folder (see FIG. 12). Once the user has selected the original music folder, the screen displays the size of data stored on both the original music folder and the folder stored on the iMusicDrive (see FIG. 13). Displaying the size of data stored in each folder allows the user to confirm that the music files have been successfully transferred from the original music folder to the iMusicDrive. The example screen presented in FIG. 13 also prompts the user to delete the original music folder by clicking on the “Delete My Old iTunes Folder.” Once the deletion is complete, the example screen shown in FIG. 14 notifies the user that the original music folder has been deleted and displays the size of data stored on the iMusicDrive.

Certain implementations may have one or more of the following advantages. Exact copies of data from a first data storage device can be synchronized with one or more redundant data storage devices in a single process. In some implementations, the process of synchronizing data can be independent of the storage device. Furthermore, given the system message log file is created in real-time, the synchronization process occurs sub-real time. In addition, operating systems can create the mirrored data without the need for additional hardware components such as RAID controllers. In some implementations, writing the data to the redundant storage devices can be postponed until a more advantageous time.

Various aspects of the system may be implemented in hardware, software or a combination of hardware and software. Circuitry, including dedicated or general purpose machines, such as computer systems and processors, may be adapted to execute machine-readable instructions to implement the techniques described above. Computer-executable instructions for implementing the techniques can be stored, for example, as encoded information on a computer readable medium such as a magnetic floppy disk, magnetic tape, or compact disc read only memory (CD-ROM).

A number of embodiments of the invention have been described. Nevertheless, various modifications may be made without departing from the spirit and scope of the invention. Other implementations are within the scope of the claims.

What is claimed is:

1. A computer-implemented method of synchronizing data between two data storage devices comprising:
receiving, from an operating system, a file system message that includes an instruction to modify a first data storage device; and
executing the instruction on first and second data storage devices.

2. The method according to claim 1 wherein receiving a file system message that includes an instruction to modify a first data storage device comprises:
intercepting file system messages from the operating system before the file system messages are received by a file system event handler;
recording, in a log file, an intercepted file system message that includes an instruction to modify a first data storage device; and
reading the instruction from the log file.

3. The method according to claim 2 including:
passing intercepted file system messages that do not include an instruction to modify a first data storage device to the file system event handler.

4. The method according to claim 2 including:
passing the intercepted file system message that includes an instruction to modify a first data storage device to the file system event handler after the intercepted file system message that includes an instruction to modify a first data storage device has been recorded in the log file.

5. The method according to claim 2 wherein reading and executing the instruction on the first data storage device occur directly after recording the intercepted file system message in the log file.

6. The method according to claim 2 wherein reading and executing the instruction on the second data storage device do not occur until a fixed time period has elapsed after recording the intercepted file system message in a log file.

7. The method according to claim 2 wherein reading and executing the instruction on the second data storage device occur in response to a user-initiated command.

8. The method according to claim 2 including:
verifying that the second data storage device includes an exact copy of the data stored on the first data storage device.

9. The method according to claim 8 including:
copying data that is not included on the second data storage device, from the first data storage device to the second data storage device and
deleting data that is not included on the first data storage device from the second storage device.

10. The method according to claim 2 including:
verifying the data stored on the first data storage device and on the second data storage device are not corrupted.

11. The method according to claim 1 wherein the instruction to modify a first data storage device includes one or more of the following instructions: renaming a file, renaming a folder, deleting a file, deleting a folder, creating a file, creating a folder and modifying a file.

12. An article comprising a machine-readable medium storing machine-executable instructions that, when applied to a machine, cause the machine to:
intercept file system messages, supplied by an operating system, before the file system messages are received by a file system event handler;
record, in a log file, an intercepted file system message that includes an instruction to modify a first data storage device;
read the instruction from the log file; and
execute the instruction on a second data storage device.

13. The article of claim 12, including instructions that, when applied to the machine, cause the machine to:
pass the intercepted file system messages to the file system event handler.

14. The article of claim 13, including instructions that, when applied to the machine, cause the machine to:
verify that the second data storage device includes a copy of the data stored on the first data storage device

15. The article of claim 13 wherein the instructions further cause the machine to:
copy data that is not included on the second data storage device from the first data storage device to the second data storage device and
delete data that is not included on the first data storage device from the second storage device.

16. The article of claim 13, including instructions that, when applied to the machine, cause the machine to:
verify that the data stored on the first data storage device and stored on the second data storage device are not corrupted.

17. The article of claim 12 including instructions that, when applied to the machine, cause the machine to:
pass the intercepted file system message that includes an instruction to modify a first data storage device to the file system event handler after the intercepted file system message that includes an instruction to modify a first data storage device has been recorded in the log file.

18. The article of claim 12 including instructions that, when applied to the machine, cause the machine to:
read and execute the instruction to modify a first data storage on a second data storage device directly after recording the intercepted message in the log file.

19. The article of claim 12 including instructions that, when applied to the machine, cause the machine to:
read and execute the instruction to modify a first data storage device on a second data storage device after a fixed time period has elapsed following the recording of the intercepted message in the log file.

20. The article of claim 12 including instructions that, when applied to the machine, cause the machine to:
read and execute the instruction to modify a first data storage device on a second data storage device in response to a user-initiated command.

21. The article of claim 12 wherein the instruction to modify a first data storage device includes at least one of the following: renaming a file, renaming a folder, deleting a file, deleting a folder, creating a file, creating a folder, and modifying a file.

22. The article of claim 12 including instructions that, when applied to the machine, cause the machine to:
hide the appearance of the second data storage device on the machine from the user.

23. A system for synchronizing data between two data storage devices comprising:
a first data storage device;
a second data storage device;
a graphical user interface;
an operating system;
a file system event handler;
a log file; and
application software stored by the system and configured to:
intercept file system messages, provided by the operating system, before the file system messages are received by the file system event handler;
record, in the log file, an intercepted file system message that includes an instruction to modify the first data storage device;
read the instruction; and
execute the instruction on the second data storage device.

24. The system according to claim 23 wherein the application software is configured to:
pass intercepted file system messages that do not include an instruction to modify a first data storage device to the file system handler.

25. The system according to claim 23 wherein the application software is configured to:
pass the intercepted file system message that includes an instruction to modify a first data storage device to the file system event handler after the intercepted file system message that includes an instruction to modify the first data storage device has been recorded in the log file.

26. The system according to claim 23 wherein the application software is configured to:
read and execute the instruction directly after recording the intercepted file system message in the log file.

27. The system according to claim 23 wherein the application software is configured to:
read and execute the instruction in response to a user-initiated command, wherein the user-initiated command is received through the graphical user interface.

28. The system according to claim 23 wherein the application software is configured to:
verify that the second data storage device includes a copy of the data stored on the first data storage device.

29. The system according to claim 23 wherein the application software is further configured to:
copy data that is not included on the second data storage device from the first data storage device to the second data storage device and
delete data that is not included on the first data storage device from the second storage device.

30. The system according to claim 23 wherein the application software is configured to:
verify the data stored on the first data storage device and the data stored on the second data storage device are not corrupt.

31. The system according to claim 23 wherein the instruction to modify the first data storage device includes at least one of the following: renaming a file, renaming a folder, deleting a file, deleting a folder, creating a file, creating a folder and modifying a file.

32. The system according to claim 23 wherein the first data storage device comprises magnetic, optical or semiconductor read-write memory.

33. The system according to claim 23 wherein the second data storage device comprises magnetic, optical or semiconductor read-write memory.

34. The system according to claim 23 wherein the first data storage device and the second data storage device comprise the same type of memory.

35. The system according to claim 23 wherein the log file is a text file.
